(19) United States
(12) Patent Application Publication
(10) Pub. No.: US 2006/0032097 A1
(43) Pub. Date: Feb. 16, 2006

(54) Display and storage device and mount

(76) Inventor: Jeffrey L. Cope, Augusta, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/919,038

(22) Filed: Aug. 16, 2004

(51) Int. Cl. G09F 7/04

(52) U.S. Cl. 40/600

(57) ABSTRACT

A panel (11) has a plurality of holes (12). A mount (6) has a first surface (20), a second surface (9), and a post (18) extending from the second surface. The post of the mount is inserted into a hole in the panel. The memento (33) is secured to the first surface of the mount by an attachment device (17, 19), such as an adhesive or a magnet or a magnetic disk. A retainer (15) having a hole (12) may be used along with a recessed area or countersink (13) in the panel so that the post of the mount goes through the hole in the retainer to provide additional support or security.

### BACKGROUND OF THE INVENTION

1. Field of the Invention

The present invention relates to devices and mounts to store and/or display articles, such as mementos.

2. Description of Related Art

Existing display and storage devices are generally limited in their ability to accommodate articles of different sizes and/or shapes, may be relatively complex and/or expensive, and/or do not provide for convenient addition of articles to, or removal of articles from, the display or storage device.

### SUMMARY OF THE INVENTION

An exemplary embodiment of the present invention provides a device to display, store, or both display and store, an article. The device includes a panel having a hole and a retainer. The article may be a memento or may be a mount. A memento may have a post extending therefrom. The mount may include a first surface, a second surface, and a post extending from the second surface. An adhesive may be interposed between the first surface and a memento to secure the memento to the mount. The post of the memento or the mount may be inserted into and removed from the hole.

Another exemplary embodiment of the present invention provides a device to secure an article to a panel having a hole. The device includes a mount. The mount may include a first surface, a second surface, and a post extending from the second surface. An adhesive may be interposed between the first surface and a memento to secure the memento to the mount. The post can be inserted into and removed from the hole in the panel.

Other features and advantages of the present invention will become apparent upon reviewing the following detailed description and drawings of the embodiments and the appended claims.

### BRIEF DESCRIPTION OF THE DRAWING

FIG. 1 is an illustration of an exemplary embodiment of the display and/or storage device of the present invention.

FIG. 2 is an illustration of an exemplary embodiment of a front panel and an optional rear panel.

FIG. 3 is an illustration of an exemplary article or other object being attached to a panel.

FIG. 4 is an illustration of one exemplary embodiment of an article having a desired memento and one embodiment of a subcarrier or mount.

FIG. 5 is an illustration of another exemplary embodiment of a mount.

FIG. 6 is an illustration of another exemplary embodiment of a mount.

FIG. 7 is an illustration of another exemplary embodiment of a mount.

FIG. 8 is an illustration of another exemplary embodiment of a mount.

FIGS. 9A and 9B are illustrations of another exemplary embodiment of a mount.

FIGS. 10A and 10B are illustrations of another exemplary embodiment of a mount.

FIGS. 11A and 11B are illustrations of an exemplary end cap, or plug, as used with a panel and a retainer.

FIG. 12 is an illustration of another exemplary embodiment of a mount.

FIG. 13 is an illustration of an exemplary embodiment using a front panel, a rear panel, a retainer, and an article having a post.

FIGS. 14A and 14B are illustrations of another exemplary embodiment of an end cap, or plug, as used with a panel and a retainer.

FIGS. 15A-15C are illustrations of another exemplary embodiment of a mount.

FIGS. 16A-16D are illustrations of other exemplary embodiments of a mount or a ledge.

### DETAILED DESCRIPTION

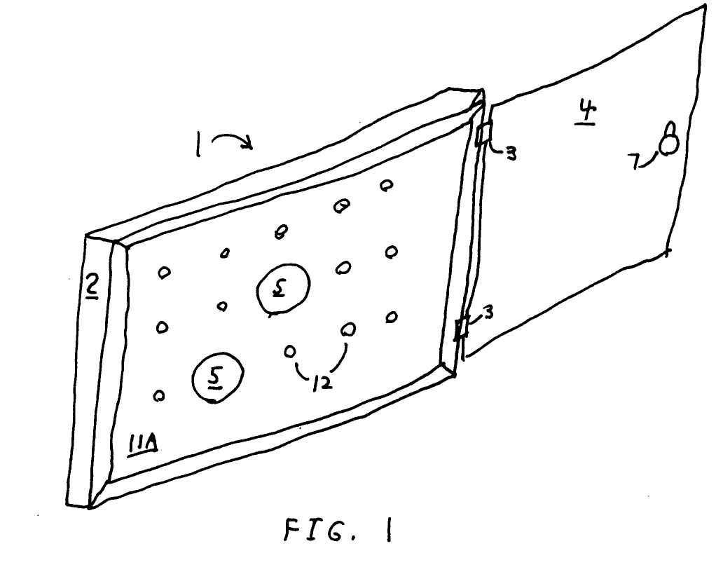

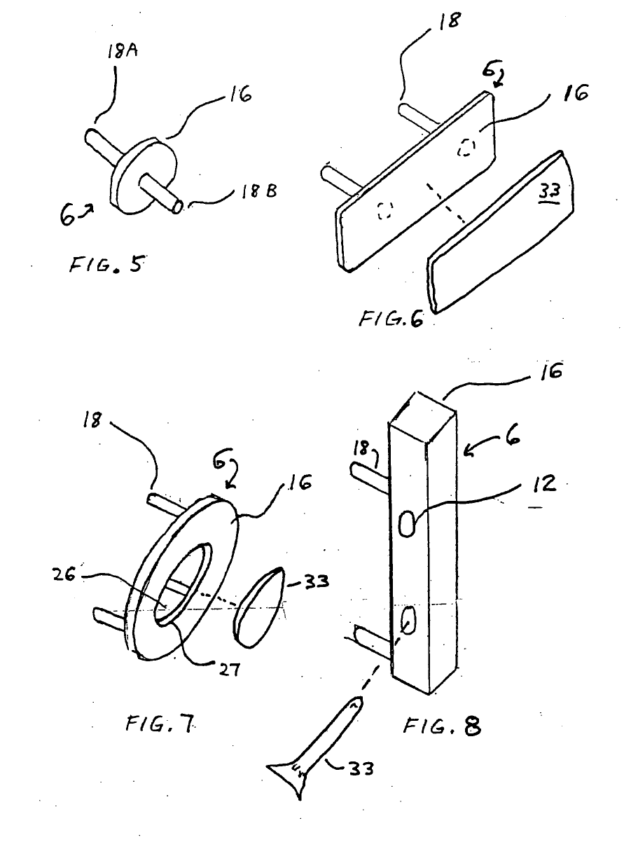

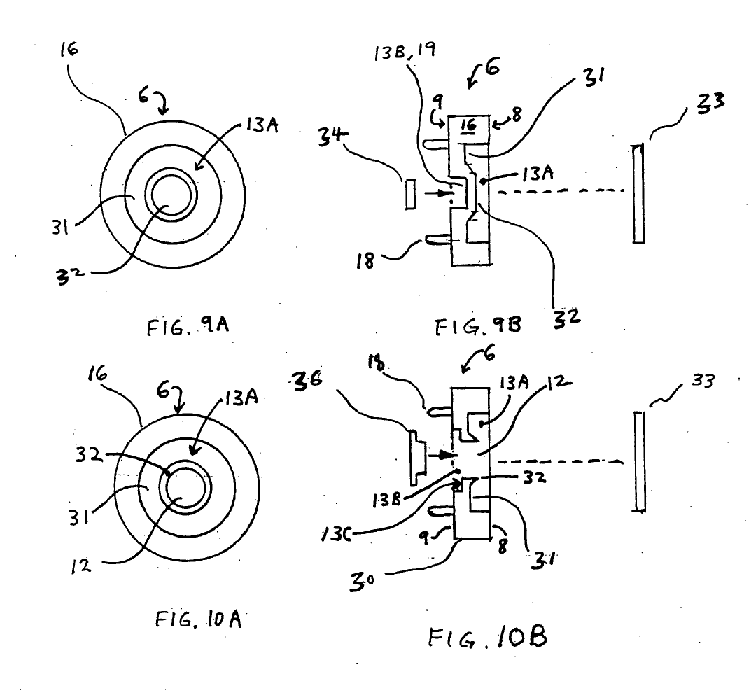

Turn now to the drawing in which like numerals and characters represent like components throughout the several figures. FIG. 1 is an illustration of an exemplary embodiment of the display and/or storage device or carrier 1 of the present invention. The device 1 preferably includes at least a front panel 11A having a plurality of holes 12 for mounting articles 5. An article 5 may be an object which can be directly mounted in the device 1 or, as shown in FIG. 4, may be the combination of a mount or subcarrier 6 along with a memento 33 which cannot be directly mounted to the device 1. An article 5 may be, for example, a golf tee, a golf ball marker, a golf pencil, a nameplate, a medallion, or other such memento, such as a collectible, other item, or a mount with such an item.

In the embodiment shown, the device 1 preferably also has a border or frame 2, which may be for esthetic or visual appeal, support, protection, or a combination thereof. The border or frame 2 may be of any construction appropriate for the desired level of protection, security, or aesthetic appeal, for example, wood, metal, plastic, real or synthetic rubber, cardboard, resinous material, Plexiglass®, Styrofoam®, or other desired material, or any desired combination of the foregoing. The border or frame 2 may also be partially or completely covered, if desired, for example, by paint, cloth, felt, paper, or any other material or combination of materials which produces the desired appearance.

In the embodiment shown, the device 1 preferably also has a cover 4, which is connected to the border 2 by, for example, hinges 3. The cover 4 may be partially or substantially transparent, or partially or substantially opaque, as desired, and may be any desired color. The cover 4 may be of any construction appropriate for the desired level of protection, security, or aesthetic appeal, for example, wood, metal, plastic, real or synthetic rubber, cardboard, resinous material, Plexiglass®, Styrofoam®, or other desired material, or any desired combination of the foregoing. The cover 4 may also be partially or completely covered, if desired, for example, by paint, cloth, felt, paper, or any other material or combination of materials which produces the desired appearance. The cover 4 may be secured in a closed position by a latch or lock 7 or other closure or security mechanism, for example, snaps, hook and loop fasteners, magnets and magnetic materials, of any construction appropriate for the desired level of protection or security. For convenience of illustration, the cover 4 is shown as opening to the right side, but the cover 4 may open to any desired position, for example, the left side, the top, or the bottom. Further, the cover 4 need not be connected to the border 2 by hinges, but may be connected by any desired means or device, or may not be connected but may simply lift out from a recess in the border 2. In addition, the cover 4 may have two or more sections (not shown) which open in different directions. For example, the cover 4 may have two sections, one which opens to the right side and another which opens to the left side.

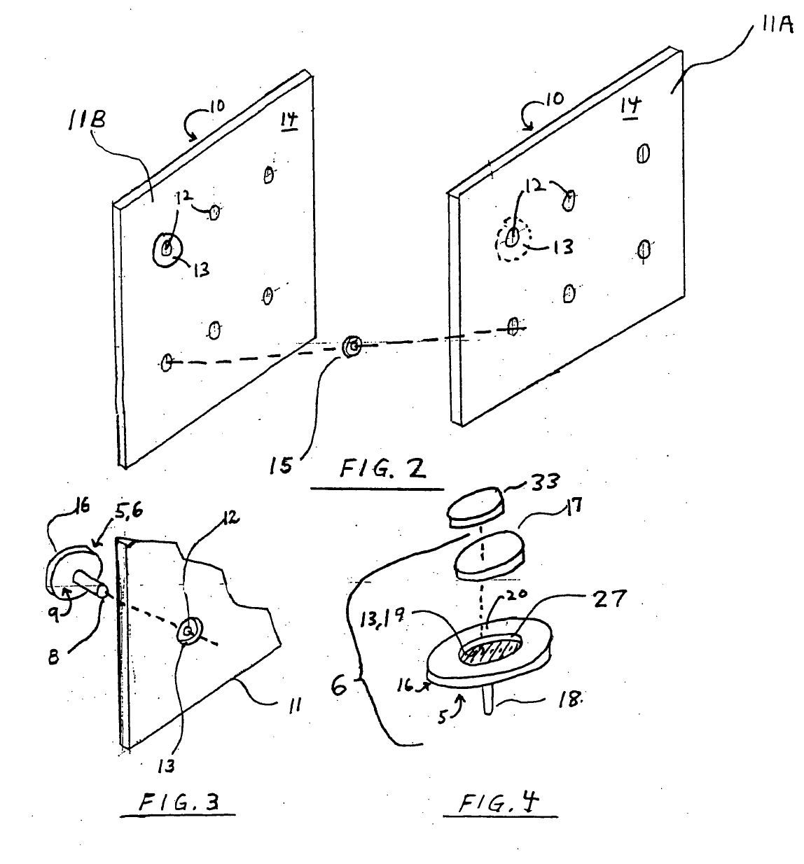

FIG. 2 is an illustration of an exemplary embodiment of the front panel 11A and an optional rear panel 11B. The front panel 11A has a plurality of holes 12 and the optional rear panel 11B also has a plurality of holes 12, preferably corresponding to those holes 12 in panel 11A. The panels 11A and 11B may be made of the same material or may be made of different materials. For example, a panel 11A, 11B may be made of real or synthetic rubber, plastic, wood, metal, leather, cardboard, resinous material, Plexiglass®, Styrofoam®, or other desired material, or any desired combination of the foregoing, which can provide any necessary support for the article 5. A panel 11A, 11B may also be partially or completely covered, if desired, for example, by paint, cloth, felt, paper, or any other material or combination of materials which produces the desired appearance. Panels 11A and 11B may be detachably or permanently held together by any desired and appropriate means, for example, nails, screws, pegs, glue, epoxy, clips, double-sided tape, the frame 2, a hinge and/or hinges and/or a latch and/or latches, etc.

The holes 12 preferably go through the panel 11A but may or may not, as desired, go through the panel 11B. Preferably, the holes 12 in at least one of the panels 11A, 11B is manufactured to provide a countersink or recessed area 13 to accommodate a retainer 15. The area 13 may be on the back side 10 of a panel 11A, 11B. The area 13 may also be on the front side 14 of a panel 11A, 11B. Further, there may be two areas 13, for example, one on the back side of panel 11A and one on the front side of panel 11B, so that each panel 11A, 11B encloses at least part of a retainer 15. If necessary or desired, such as for additional support or rigidity, more than one retainer 15 may be used, and each retainer 15 may have a separate area or areas 13.

Retainers 15 may be any retainer suitable for securing the article 5, including, by way of example, a grommet, an “O”-ring, a clip, a nut, a disk or other shape of a perforated or perforable material, such as real or synthetic rubber, wood, plastic, metal, etc.

For convenience of illustration, the holes 12 are shown in a linear grid configuration. However, the holes 12 may be in any desired configuration such as, for example, a diagonal grid configuration, a circular configuration, a triangular configuration, a combination of similar or different configurations, overlapping configurations, random or pseudo-random configurations, configurations which match or complement the article or memento, etc. Similarly, the spacing between holes 12 may be any desired spacing consistent with holding the articles 5. For example, one sports conference may have ten teams and another sports conference may have fifteen teams so that, for visual appeal and due to the size, shape, and/or number of articles 5 for the teams in a particular conference, it may be desirable to have the holes 12 arranged differently for the ten-team conference than for the fifteen-team conference.

In addition, a retainer 15 may not be necessary, depending upon the material used for a panel 11, such as, for example, where a panel 11 comprises a rubber sheet or rubber strip, either perforated or perforable, so that a hole 12 is made, or may be made, in the panel 11 to secure the article, mount or memento.

FIG. 3 is an illustration of an exemplary article 5 or mount 6 being attached to a panel 11A. In this example, the article 5 may be memento, for example, a collectible item, such as a stem-type ball marker having a body 16 and a post 18, such as, for example, a stem, peg or other extension. The body 16 has a first surface (not shown) and a second surface 9, from which the post 18 extends. The post 18 goes through the hole 12 in the panel 11A. A retainer 15 (not shown) in the recess 13 may be used to secure the article 5 to the panel 11A.

The use of a recess 13 and a retainer 15 is optional and is not a requirement. For example, once the post 18 is inserted then the hole 12 of the panel 11A may grip the post 18 sufficiently to prevent accidental removal of the post 18. This may be accomplished, for example, by the hole 12 being approximately the same size as, or smaller than, the post 18 or by the panel 11A, 11B being made of a material that will grip the post 18. If two panels 11A, 11B are used, then retention of the post 18 may also be accomplished by, for example, causing the hole in panel 11A to be slightly offset from the hole in panel 11B.

The mount 6 may be of any construction appropriate for the desired level of protection, security, or aesthetic appeal, for example, wood, metal, plastic, real or synthetic rubber, cardboard, resinous material, Plexiglass®, Styrofoam®, or other desired material, or any desired combination of the foregoing. The mount 6 may also be partially or completely covered, if desired, for example, by paint, cloth, felt, paper, or any other material or combination of materials which produces the desired appearance.

FIG. 4 is an illustration of one exemplary embodiment of an article 5 having a desired memento 33, for example, a ball marker, and one embodiment of a subcarrier or mount 6. The mount 6 has a body 16 and a post 18. The body 16 has a first surface or face 20, a second surface 9, and a post 18 extending from the second surface. In this embodiment, there is also a recessed area or cavity 13 in the body 16, an adhesive 19, and an insert 17. Post 18 may be, for example, a stem, peg or other extension. The adhesive 19 may be, for example, glue, epoxy, rubber cement, sticky tape, or some other substance which holds the insert 17 to the body 16. In one exemplary embodiment, the insert 17 is a magnet and the memento 33 is magnetic so that the insert 17 holds the memento 33. In another embodiment, the insert 17 is magnetic and the memento 33 is a magnet so that, again, the insert 17 holds the memento 33. As used herein, the term “magnetic” means a characteristic of a material, component, or device so that it is attracted to a magnetic field, for example, steel, iron, certain ceramics, and ferromagnetic materials are all magnetic materials. If magnetized, such an item is still considered to be magnetic, but also becomes a magnet. If the recessed area 13 is sufficiently shallow, or non-existent, then the insert 17 may be deleted, and the adhesive 19 may directly hold the memento 33 to the body 16. However, care should be taken as some adhesives may attack, dissolve, harden or otherwise damage the memento 33. Components 17 and 19, individually or in combination, may be considered to be an attachment device.

The memento 33 may be larger than, smaller than, or the same size as, the body 16. If the memento is smaller than the body 16, then the face portion 20 of the body, which is outside of the recessed area 13 but not covered by the memento 33, may be used to write or inscribe some information about the memento 33. This is useful in the case of a memento which has a color, or colors, or picture, or date, or other characteristic but which, by itself, does not necessarily inform the viewer of its significance. For example, a ball marker may show a picture of a person or a fairway but not indicate the name of the person, the fairway, the course, or the date. This information can be placed on the face portion 20 so as to inform the viewer, without adversely affecting the value or desirability of the memento 33.

This information may also be placed on any desired and appropriate area of a body 16 of the various exemplary embodiments described herein. The information may be visible when the memento 33 is present, such as on a part of the body 16 which is not covered by the memento 33, or may be visible only when the memento 33 is not present, such as an indicator of what memento 33 that particular mount 6 is intended to hold. The information may be placed on the body 16 by any desired and appropriate method, for example, printing, scribing, decals, molding, etc.

FIG. 5 is an illustration of another exemplary embodiment of a mount 6. The mount 6 has a body 16 and two posts 18A, 18B. One post, for example post 18A, may be used to secure the mount 6 to a panel 11, and the other post, or leg, 18B, may be used to support a memento 33 (not shown). The post 18A and the post or leg 18B may or may not be identical. For example, the post 18A may be a different length or diameter or shape than leg 18B. This type of mount is useful, for example, with a memento which has a hole into which the leg 18B may be inserted. This type of mount is also useful, for example, with a memento which has a string, loop, or other feature into which the leg 18B may be inserted. Two or more of this type mount 6 may be used, along with a section of rigid or semi-rigid material (not shown) of the desired length and width to form a shelf or ledge upon which one or more mementos can be placed. Preferably, this section of material would have holes into which the legs 18 could be inserted. However, this section of material could also simply rest on the legs 18.

FIG. 6 is an illustration of another exemplary embodiment of a mount 6. The mount 6 has a body 16 and two or more posts 18. The body 16 may be an elongate body, for example, rectangular, rectangular with rounded corners (as shown), oval, or elliptical. The body 16 may also be another desired shape, for example, triangular, square, pentagonal, hexagonal, irregular shape, etc. The shape of the body 16 is preferably selected to be compatible with the shape of the memento 33 (not shown). One use of the mount 6, in the embodiment shown, is for a nameplate memento. The memento 33 may be affixed to the mount 6 by any desired attachment method or device, as mentioned above, for example, an adhesive, magnetism, etc.

FIG. 7 is an illustration of another exemplary embodiment of a mount 6. The mount 6 has a body 16, an opening 26, an inner rim 27 of the opening 26, and two or more posts 18. The body 16 may be a circular body, as shown, or may be a roughly circular body, for example, pentagonal, hexagonal, etc. The body 16 may also be an elongate body. The body 16 may also be another desired shape. The shape of the body 16 is preferably selected to be compatible with the shape of the memento 33. One use of the mount 6, in the embodiment shown, is for a circular nameplate memento. The memento 33 may be affixed to the mount 6 by any desired attachment method or device, as mentioned above. As with the embodiment of FIG. 4, the body 16 may be larger, smaller, or the same size as the memento 33. Also, in the embodiment of FIG. 7, the size of the opening 26 may be selected to match the size of the memento 33 so that the memento may be held in place by a friction fit, or by a suitable adhesive or glue.

FIG. 8 is an illustration of another exemplary embodiment of a mount 6. The mount 6 has a body 16, one or more holes 12, and two or more posts 18. The holes 12 are shaped appropriately for the shape of the memento 33 to be held. Also, the holes 12 may have different shapes so that different types of mementos may be held, for example, one hole 12 may have a hexagonal shape for holding a memento golf pencil, and another hole 12 may have a round shape for holding a memento golf tee. The holes 12 may go completely through the body 16 or may only have a nominal depth, depending upon the nature of the memento 33 to be held. The body 16, as shown, is a rectangular parallelepiped, which is preferable, but not necessary, for securing elongate mementos, such as golf pencils and golf tees. However, the body 16 may be any desired shape or thickness commensurate with the characteristics of the memento and/or the desired visual effect.

FIGS. 9A and 9B are illustrations of another exemplary embodiment of a mount 6. Referring to FIG. 9A, which is the top view, the mount 6 has a body 16, a top cavity or recess 13A, a floor 31 of the cavity 13A, and a support area or ledge 32. FIG. 9B is cutaway side view which illustrates the posts 18, the body 16, the cavity 13A, the floor 31, and the support area 32. The top cavity 13A preferably does not extend completely through the body 16, but may so extend if desired. There is also a bottom cavity or recess 13B into which a magnet 34 is inserted. The magnet 34 may be held in the bottom cavity 13B by a friction fit or by an adhesive 19. The magnet 34 thus holds a magnetic memento 33 in the body 16. The support area 32 determines how far into the cavity that the memento 33 may go. The top cavity 13A and the support area 32 define an effective cavity depth, and are preferably sized so that the memento 33 will fit therein and so that the outer surface of the memento 33 will be approximately flush with the surface 8 of the body 16. However, the effective cavity depth provided by the top cavity 13A and the support area 32 may be thinner or thicker than the thickness of the memento 33 so that the memento 33 may extend above or be recessed below the surface 8 of the body 16, as desired.

Alternatively, the component 34 may be magnetic and the memento 33 may be a magnet. Recessing the memento 33 serves to prevent the memento from being accidentally knocked off or removed, and to make theft of the memento more difficult. If the clearance between the edge of the memento 33 and the recess 13A is small so that prying out the memento is difficult, then one or more holes (not shown) in the body 16 may be used to provide access to the memento so that the memento can be pushed out from inside the body 16.

In another exemplary implementation and use of the mount 6, memento 33 may be inserted into the recess 13A and held in place by pressure or friction fit against the sides of the recess 13A. In this implementation, the item 34 is not required, and the memento 33 need not be a magnet nor need be magnetic.

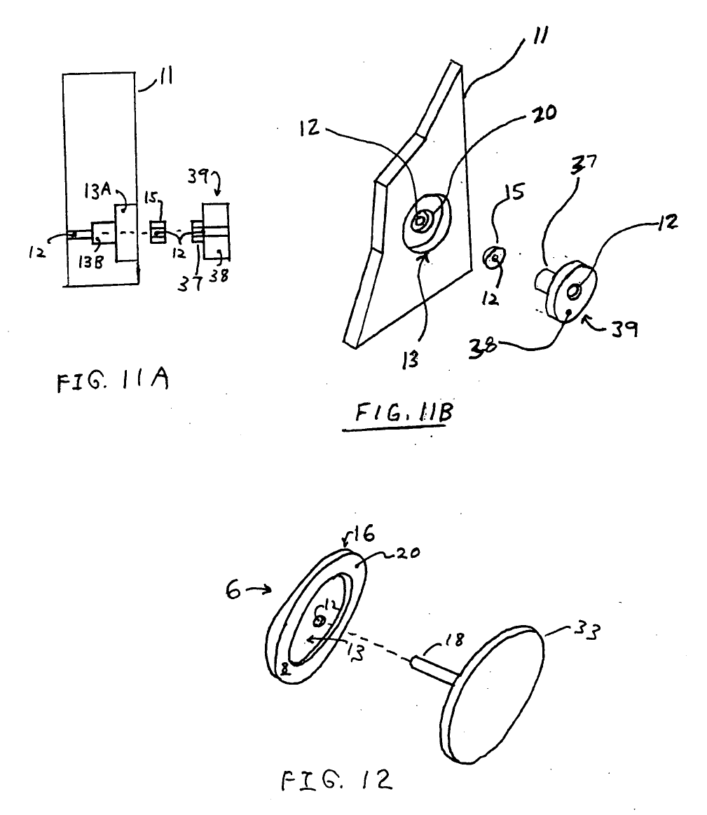

FIGS. 10A and 10B are illustrations of another exemplary embodiment of a mount 6. Referring to FIG. 10A, which is the top view, the mount 6 has a body 16, a top cavity or recess 13A, a floor 31 of the cavity 13A, a support area or ledge 32, and, if desired, a hole 12. As shown in FIG. 10B, the top cavity 13A and the bottom cavity, or countersink area, 13B are preferably, but not necessarily, connected by the hole 12. Alternatively, one could consider components 12, 13A, and 13B as defining a hole through the body 16. In this embodiment, a disk 36 is magnetic and the memento 33 is a magnet. The disk 36 is inserted into the cavity 13B and is restrained by the shelf 13C of countersink area 13B. The disk 36 may be held in place by a friction fit, by an adhesive 19 (not shown), by causing part of the body 16 to flow or extend over the disk 36 after insertion, etc. The support area 32 determines how far into the cavity that the memento 33 may go. The top cavity 13A and the support area 32 define an effective cavity depth, and are preferably sized so that the memento 33 will fit therein and so that the outer surface of the memento 33 will be approximately flush with the surface 8 of the body 16. However, the effective cavity depth provided by the top cavity 13A and the support area 32 may be thinner or thicker than the thickness of the memento 33 so that the memento 33 may extend above or be recessed below the surface 8 of the body 16, as desired. Alternatively, the component 36 may be magnetic and the memento 33 may be a magnet. The memento may also be recessed, for example, as described with respect to FIGS. 9A and 9B.

In another exemplary implementation and use of the mount 6, memento 33 may be inserted into the recess 13A and held in place by pressure or friction fit against the sides of the recess 13A. In this implementation, the item 34 is not required, and the memento 33 need not be a magnet nor need be magnetic.

FIGS. 11A and 11B are illustrations of an exemplary end cap, or plug, 39 as used with a panel 11 (11A, 11B) and a retainer 15. As shown in FIG. 11A, which is a cutaway view, a panel 11 has a first recessed or countersink area 13A, a second recessed area 13B, and a hole 12. The retainer 15 is preferably inserted into the recessed area 13B, and also has a hole 12. A plug 39 is preferably inserted into the countersink areas 13A and 13B, and has an end disk 38, a post 37, and a hole 12 which preferably extends into and, if desired, through the post 37, and preferably, but not necessarily, extends into and, if desired, through the disk 38. The plug 39 may be used to provide additional support for the memento (not shown), to keep the retainer 15 from falling out when it is not being used to retain a memento, or to present a more smooth, finished appearance for the panel 11. In use, the post 18 of an article 5 or mount 6 would extend through hole 12 of the panel 11, through the retainer 15, and possibly, but not necessarily, into or through the plug 39. Although the retainer 15 could be held in place by an adhesive, the use of the plug 39 allows the retainer 15 to be conveniently removed or replaced, such as when the retainer 15 may become worn or damaged. The plug 39 is preferably held in place in the panel 11 by friction, such as when the diameter or size of the end disk 38 of the plug 39 is approximately the same as or slightly greater than the diameter or size of the countersink area 13A, or when the diameter or size of the post 37 is approximately the same as or slightly greater than the diameter or size of the recess 13B. The plug 39 may be conveniently removed, thereby exposing the retainer 15 for easy removal, by prying out the plug 39, by pushing an object through the hole 12 in the panel 11 and pushing the plug 39 out, or by pushing an object through the hole 12 in the end disk and popping out the plug 39. The plug 39 may also be held in place by other means, if desired, for example, an adhesive. It is also contemplated that the post 18 and the hole 12 of the plug 39 may be threaded so as to provide additional security against accidental or unauthorized release. FIG. 11B illustrates the insertion of the retainer 15 and the plug 39 into the panel 11A, 11B.

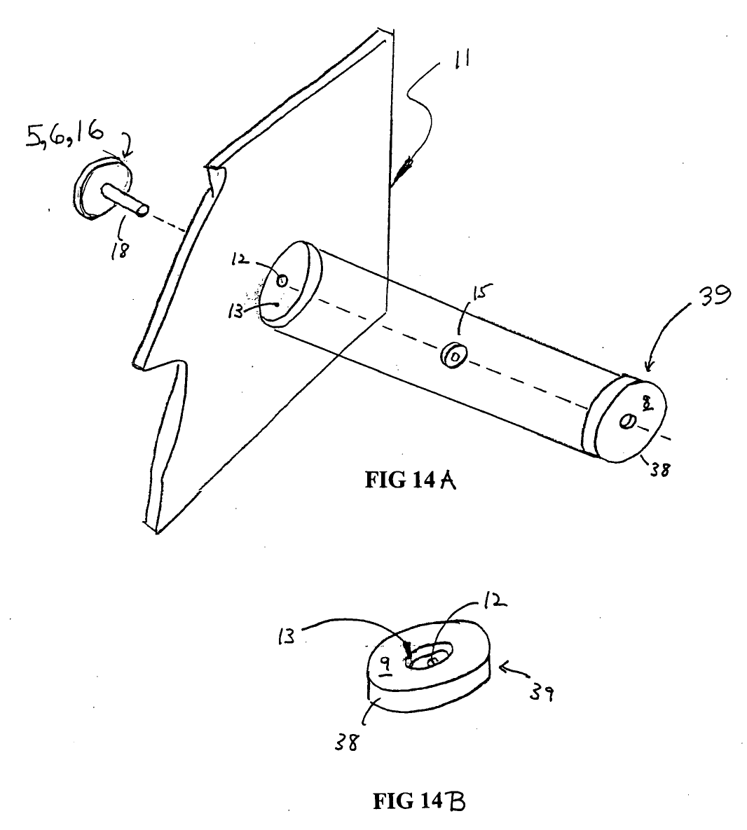

In an alternative embodiment, the post 37 can be partially or completely eliminated, such as when a panel 11 is thin, as in FIG. 14.

FIG. 12 is an illustration of another exemplary embodiment of a mount 6. The mount 6 preferably includes a body 16, a face portion or area 20 of the front surface 8, a recessed area 13, and a through-hole 12. This mount may be used, for example, when a memento 33 may also have a post 18, but is of a size which is not appropriate for the display, such as when the diameter or size of the memento 33 is noticeably smaller than the diameter or size of the countersink area 13 of a panel 11. This post 18 of the memento 33 is preferably inserted through the hole 12 of the mount 6, and then inserted into a hole 12 (not shown) of a panel 11 (not shown). Thus, the body 16 and the recess area 13 are selected in consideration of the memento 33 so as to provide the desired relationship of the top surface of the memento 33 with respect to the front or top surface 8 of the panel 11, and also to reduce or eliminate any gap around the outside of the memento 33. The face 20 may be used, if desired, as described with respect to FIG. 4. Recession of the memento 33, if desired, may provide the benefits described with respect to FIGS. 9A and 9B.

If it is not desired that the memento 33 have a post 18, then the post can be removed, such as by breaking it off, or cutting it off, and grinding the stub down if necessary, so that the embodiment of FIG. 4 can be used for the memento. The embodiment of FIG. 4 allows the memento 33 to be conveniently tilted and removed.

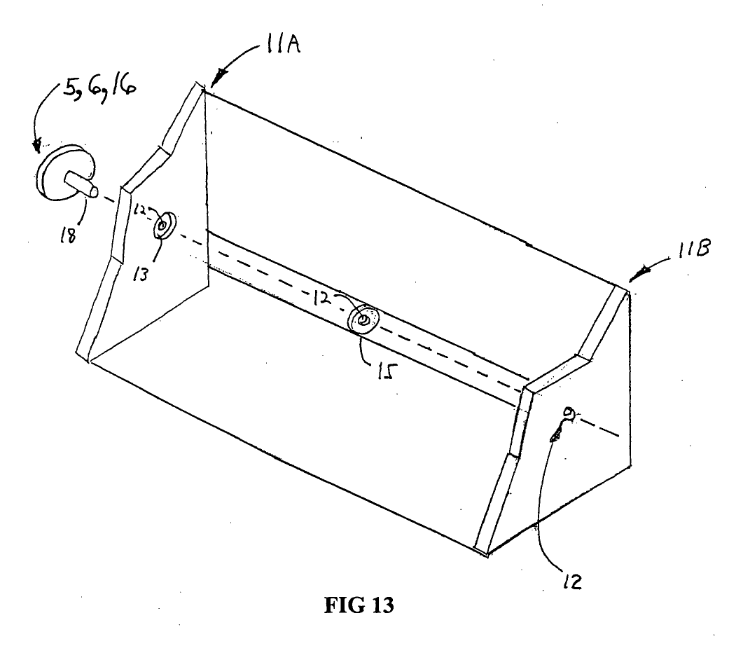

FIG. 13 is an illustration of an exemplary embodiment using a front panel 11A, a rear panel 11B, a retainer 15, and an article 5, 6, 16 having a post 18. The front panel 11A has a through-hole 12, and a countersink area 13. The retainer 15 is preferably inserted into the countersink area 13. The rear panel 11B has a hole 12 which preferably, but not necessarily, is a through-hole. The article 5, may be, for example, a mount 6 having a post 18, or a memento 16 having a post 18. The post 18 is inserted through the hole 12 of the front panel 11A, through the hole 12 of the retainer 15, and preferably into or through the hole 12 of the rear panel 11B. The post 18 may be held in the retainer 15 by, for example, a friction fit or an adhesive. The panels 11A, 11B may be held together by the frame 2, by an adhesive placed between the panels, or by any other desired and appropriate means.

FIGS. 14A and 14B are illustrations of another exemplary embodiment of an end cap, or plug, 39 as used with a panel 11 and a retainer 15. In this embodiment, the panel 11 has a through-hole 12, and a recessed area 13 in which a retainer 15 may be placed. The plug 39 has a body 38, a recessed area 13 in which a retainer 15 may be placed, first and second surfaces 8, 9, and a through-hole 12. The article 5, 6, 16 has a post 18. The post 18 is inserted through the hole 12 of the panel 11A, through the hole 12 in the retainer 15 or retainers 15, and preferably into or through the hole 12 of the plug 39. The post 18 may be held by the retainer(s) 15 or the plug 39 by any of the means described above, and the plug 39 may be held in the panel 11 by any of the means described above.

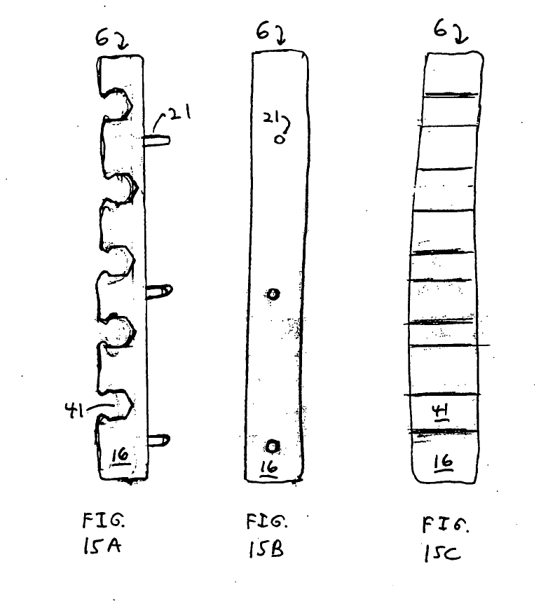

FIGS. 15A-15C are illustrations of another exemplary embodiment of a mount 6. The mount 6 has a body 16 and slots 41 in the body 16 of an appropriate shape, depth and width to hold the desired memento, and posts 18 for insertion into holes 12 in a panel 11. For example, the embodiment shown may be used to hold golf pencil or golf tee mementos (not shown). As such, it is shaped to hold cylindrical or substantially objects, for example, golf tees and some pencils, or hexagonal or substantially hexagonal objects, for example, most golf pencils. FIG. 15A is a side view, FIG. 15B is rear view, and FIG. 15C is a front view.

One example of a use of a mount 6, for example, mount 6 of FIGS. 15A-15C, is to hold collectibles 33, for example, PEZ® dispensers (not shown). In this use, the slot 41 is of a size and shape appropriate for hold such dispensers. Another example of a use of a mount 6, for example, the mount 6 of FIG. 3, is to hold trading cards (not shown), such as baseball trading cards. In this use, a part of a trading card (not shown), such as a corner, is held by the body 16 against the panel 11. One or more mounts 6 may be used to hold a single trading card or other memento 33, such as a collectible item, depending upon the size, shape and weight of the memento. Slots 41 of FIGS. 15A-15C could also be made thin, so that a trading card may be inserted edgewise into a slot 41.

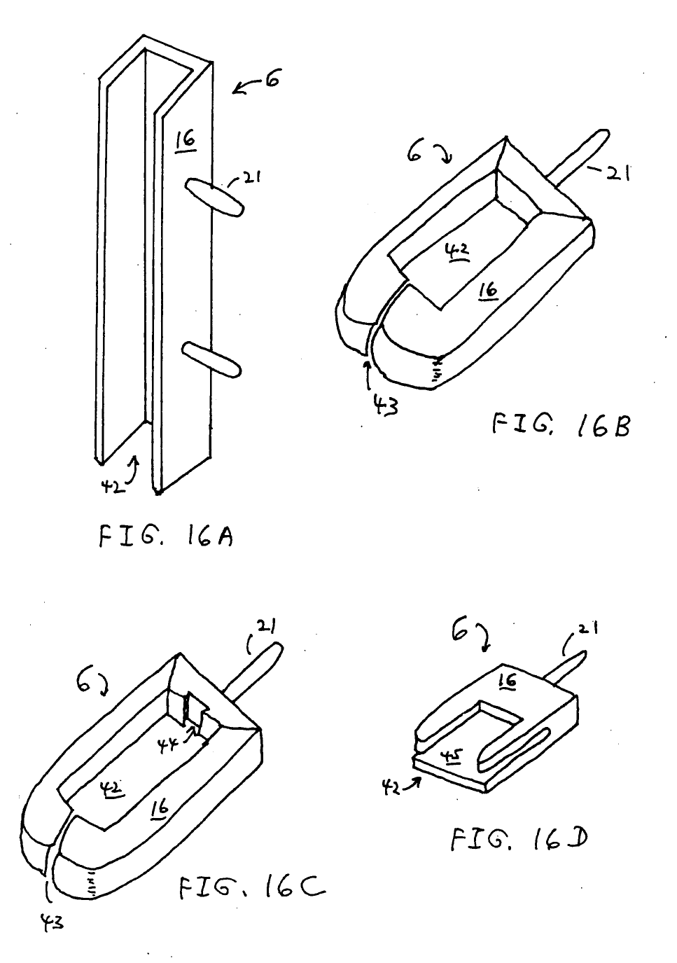

FIGS. 16A-16D are illustrations of other exemplary embodiments of a mount 6 or a ledge for holding mementos (not shown) of various shapes. A memento may be, for example, a PEZ dispenser (not shown). These embodiments have a body 16, one or more posts 21, and an opening area 42 of a shape suitable for holding or supporting the desired memento in the desired position. A slot 43 allows for expansion of the opening 42 for insertion and/or removal of the memento. A recessed area 44 allows for matching the shape of the memento. A shelf area 45 may also be used.

It will be appreciated that the length, width, diameter, or other dimension or characteristic of a component is not critical but is a design choice based upon the size, shape, weight, or other characteristic of the article or memento, and/or the desired visual effect.

For brevity in the discussion above, and to avoid repetition, the phrase “by way of example and not of limitation” has been written herein simply as “for example”.

It will be appreciated from the above that the various embodiments of the present invention provide devices for display and/or storage of articles, including, but not limited to, smaller articles, mounts for the articles, and retainers for the articles, which articles may include mounts and/or mementos. Variations of the above may suggest themselves to those of ordinary skill in the art upon reading the description above and viewing the accompanying figures. Therefore, the scope of the present invention is to be determined by the claims below.

I claim:

1. A device to display, store, or both display and store, a memento, the device comprising:
a first panel having a plurality of holes;
a mount having a first surface, a second surface, and a post extending from the second surface, the post being removably insertable into a hole of the plurality of holes; and
an attachment device to secure the memento to the mount.

2. The device of claim 1, wherein the attachment device comprises a magnetized material.

3. The device of claim 1, wherein the attachment device comprises a magnetic material.

4. The device of claim 1, wherein the attachment device comprises an adhesive.

5. The device of claim 1, wherein the attachment device releasably secures the memento to the mount.

6. The device of claim 1, and further comprising a retainer to engage the post to secure the mount to the first panel, the first panel being between the retainer and the second surface.

7. The device of claim 1, and further comprising a grommet to engage the post to secure the mount to the first panel, the first panel being between the grommet and the second surface.

8. The device of claim 1, and further comprising a cover to protect the article.

9. The device of claim 1, and further comprising a cover to protect the article, the cover being at least somewhat transparent in at least one area.

10. The device of claim 1, wherein the first panel has a recessed area around at least one hole of the plurality of holes.

11. The device of claim 1, wherein the first panel has a recessed area around at least one hole of the plurality of holes, the recessed area being on same side of the first panel into which the post is inserted into the first panel.

12. The device of claim 1, wherein the first panel has a recessed area around at least one hole of the plurality of holes, the recessed area being on the other side of the first panel from which the post is inserted into the first panel.

13. The device of claim 1, and further comprising a second panel having a plurality of holes corresponding to the plurality of holes in the first panel.

14. The device of claim 1, and further comprising a second panel having a plurality of holes corresponding to the plurality of holes in the first panel, the plurality of holes in the second panel being offset from the plurality of holes in the first panel.

15. The device of claim 1, wherein the first panel comprises a perforable material.

16. The device of claim 1, wherein the mount has a recessed area in the first surface, and wherein attachment device is located in the recessed area.

17. The device of claim 1, wherein the mount has a recessed area in the first surface, and wherein attachment device is located in the recessed area, and wherein the attachment device comprises a disk and an adhesive to secure the disk in the recessed area.

18. The device of claim 1, wherein the mount has a recessed area in the first surface, and wherein attachment device is located in the recessed area, and wherein the attachment device comprises a magnet and an adhesive to secure the magnet in the recessed area.

19. The device of claim 1, wherein the mount has a recessed area in the first surface, and wherein attachment device is located in the recessed area, and wherein the attachment device comprises a magnetic material and an adhesive to secure the magnetic material in the recessed area.

20. The device of claim 1, wherein at least some of the plurality of holes in the first panel are arranged in a predetermined configuration, and wherein the mount has a plurality of posts extending from the second surface, and wherein the plurality of posts are arranged in the predetermined configuration.

21. The device of claim 1, and further comprising a second panel having plurality of holes corresponding to the plurality of holes in the first panel, and having a side which faces the first panel, and wherein the second panel has a recessed area around at least one hole of the plurality of holes, the recessed area being on the side of the second panel which faces the first panel.

22. The device of claim 1, and further comprising a second panel having a plurality of holes corresponding to the plurality of holes in the first panel, and having a side which faces away from the first panel, and wherein the second panel has a recessed area around at least one hole of the plurality of holes, the recessed area being on the side of the second panel which faces away from the first panel.

23. The device of claim 1, wherein the first panel has a recessed area around at least one hole of the plurality of holes, and further comprising a retainer to engage the post to secure the mount to the first panel, the retainer being in the recessed area.

24. The device of claim 1, wherein the first panel has a recessed area around at least one hole of the plurality of holes, and further comprising a retainer to engage the post to secure the mount to the first panel, the retainer being in the recessed area, the first panel being between the retainer and the second surface.

25. The device of claim 1, and further comprising a second panel having a plurality of holes corresponding to the plurality of holes of the first panel, and wherein the second panel has a recessed area around at least one hole of the plurality of holes, and further comprising a retainer to engage the post to secure the mount to the first panel, the retainer being in the recessed area.

26. The device of claim 1, and further comprising a second panel having a plurality of holes corresponding to the plurality of holes of the first panel and having a side which faces the first panel, and wherein the second panel has a recessed area around at least one hole of the plurality of holes, the recessed area being on the side which faces the first panel, and further comprising a retainer to engage the post to secure the mount to the first panel, the retainer being in the recessed area.

27. The device of claim 1, and further comprising a second panel having a plurality of holes corresponding to the plurality of holes of the first panel and having a side which faces away from the first panel, and wherein the second panel has a recessed area around at least one hole of the plurality of holes, the recessed area being on the side which faces away from the first panel, and further comprising a retainer to engage the post to secure the mount to the first panel, the retainer being in the recessed area.

28. The device of claim 1, wherein the first panel has a first recessed area and a second, adjoining recessed area, the first and second recessed areas being on the side which faces away from the second surface of the mount, the second recessed area being smaller than the first recessed area and being approximately coaxial with the first recessed area, and further comprising a retainer to engage the post to secure the mount to the first panel, the retainer being in the second recessed area, and a plug to cover the retainer, the plug being in the first recessed area.

29. The device of claim 1, wherein the first panel has a first recessed area and a second, adjoining recessed area, the first and second recessed areas being on the side which faces away from the second surface of the mount, the second recessed area being smaller than the first recessed area and being approximately coaxial with the first recessed area, and further comprising a retainer to engage the post to secure the mount to the first panel, the retainer being in the second recessed area, and a plug to cover the retainer, the plug having a post and a body, the body being larger than the post, and wherein at least part of the post of the plug is in the second recessed area and at least part of the body of the plug is in the first recessed area.

30. The device of claim 1, wherein the first panel has a first recessed area and a second, adjoining recessed area, the first and second recessed areas being on the side which faces away from the second surface of the mount, the second recessed area being smaller than the first recessed area and being approximately coaxial with the first recessed area, and further comprising a retainer to engage the post to secure the mount to the first panel, the retainer being in the second recessed area, and a plug to cover the retainer, the plug having a post, a body, and a hole extending at least partially into the post, the body being larger than the post, and wherein at least part of the post of the plug is in the second recessed area and at least part of the body of the plug is in the first recessed area, and the post of the mount extends at least partially into the hole in the post of the plug.

31. A device to secure a memento to a panel having a hole, the device comprising:
a mount having a body and a post, the body having a first surface and a second surface, the post extending from the second surface, the post being removably insertable into the hole of the panel; and
an attachment device to secure the memento to the mount.

32. The device of claim 31, wherein the attachment device comprises a magnet.

33. The device of claim 31, wherein the attachment device comprises a magnetic material.

34. The device of claim 31, wherein the attachment device comprises an adhesive.

35. The device of claim 31, wherein the attachment device comprises a second post, the second post extending from the first surface of the mount.

36. The device of claim 31, wherein the attachment device releasably secures the article to the mount.

37. A mount to secure a memento to a panel having a plurality of holes, the mount comprising:
a body having a first surface, a second surface and a first recessed area, the first recessed area extending from the first surface into the body; and
a plurality of posts, the posts extending from the second surface and being removably insertable into the holes of the panel; and
wherein the memento is secured in the recessed area.

38. The mount of claim 37, wherein the first recessed area is a slot in the body.

39. The mount of claim 37, wherein the first recessed area is a hole through the body.

40. The mount of claim 37, and further comprising a raised area, the raised area being in the first recessed area, and wherein the memento is secured to the raised area.

41. The mount of claim 37, and further comprising a second recessed area and an attachment device, the second recessed area extending from the second surface into the body, the attachment device being in the second recessed area, and wherein the memento is secured to the mount by the attachment device.

42. The mount of claim 37, wherein the memento is a magnetic device, and wherein the mount further comprises a second recessed area and a magnet, the second recessed area extending from the second surface into the body, the magnet being in the second recessed area, and wherein the memento is secured to the mount by the magnet.

43. The mount of claim 37, wherein the memento is magnet, and further wherein the mount further comprises a second recessed area and a magnetic device, the second recessed area extending from the second surface into the body, the magnetic device being in the second recessed area, and wherein the memento is secured to the mount by the magnetic device.

44. A mount for a memento which is secured to a panel having a hole, the memento having a post extending therefrom, the mount comprising:
a body having a first surface, a second surface, a face area, a hole, and a recessed area, the hole being from the first surface through the body to the second surface, the recessed area being in the first surface, the face area being defined by the first surface and the recessed area; and
wherein the post of the memento passes through the hole in the mount into the hole in the panel to secure the memento to the panel; and
wherein the face area is used to present information about the memento.
